(19) United States
(12) Patent Application Publication
(10) Pub. No.: US 2007/0174360 A1
(43) Pub. Date: Jul. 26, 2007

(54) Storage system embedding database

(76) Inventor: Yuichi Yagawa, San Jose, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/329,283

(22) Filed: Jan. 11, 2006

(51) Int. Cl. G06F 17/30

(52) U.S. Cl. 707/204

(57) ABSTRACT

A storage system for storing and managing unstructured data and associated metadata which describes attributes of the unstructured data. The storage system includes a plurality of storage areas for storing the unstructured data and metadata which includes pointer information that identifies a location of unstructured data corresponding to the metadata, a server that manages the metadata, and a plurality of input/output (I/O) processing modules corresponding to the storage areas. Each I/O processing module processes commands from a host including commands requesting access to the unstructured data of a corresponding storage area. Each I/O processing module includes a client which communicates with the server to process the metadata when a command being processed by the I/O processing module affects the metadata of the unstructured data stored in the corresponding storage area.

### BACKGROUND OF THE INVENTION

The present invention relates generally to a storage system for storing and managing data. More particularly the present invention relates to a method and apparatus for configuring a storage system to store and manage unstructured data.

1. Rapid Growth of Unstructured Data

Current storage systems mainly store and manage structured data, which contain solid data structure in the data itself. An example of structured data is a database. However, recently the amount of unstructured data, which does not describe its structure in the data itself, has been increasing in datacenters. Examples of the unstructured data are emails, images such as medical images, streaming videos and so on. Unstructured data is sometimes called Content. Some may distinguish semi-structured data such as email, which partially describes its structure in the data itself, from unstructured data. However, for the purposes of the discussion herein semi-structured data is considered the same as unstructured data.

2. Compliance and Long Term Data Preservation

Unstructured data recently has become the subject of regulatory compliance requirements and as such may be required to be preserved for long periods of time. Examples of such regulations are Securities and Exchange Commission (SEC) Rule 17a-4, Health Insurance Portability and Accountability Act (HIPAA), Sarbanes Oxley Act (SOX) and so on. As per these and similar regulations this type of structured data is also called Fixed Content or Reference Information, which means that the data should never change once it has been stored.

3. Management of Unstructured Data

As per the above unstructured data does not have an indicated structure inside the data itself. However, unstructured data is usually associated with attribute data or metadata (data that describes the data) outside the data itself. The metadata is used to manage the unstructured data. Examples of the management of unstructured data using metadata includes data searching, data classification, data protection, data repurposing, data versioning, data integration, etc.

4. Conventional Storage Systems and its Disadvantages

In general, there are several types of controller based disk storages: Direct Attached Storage (DAS), Storage Area Network (SAN) attached Storage, Network Attached Storage (NAS) and Content Aware/Addressable Storage (CAS). DAS and SAN attached Storage adopt block based protocols like SCSI or Fibre Channel. NAS adopts and CAS may adopt file based protocols like Network File System (NFS) and Common Internet File System (CIFS). Conventional storage systems using the above noted protocols do not have the capability to manage attribute data or metadata. Further, there is no technique for introducing the capability to manage attribute data or metadata into storage systems so that such storage systems which are suitable for managing and storing unstructured data can manage attributer data or metadata.

Various other conventional systems are disclosed for example by the following references:
Sun Microsystems Inc. Honeycomb Technology as discussed in the references:

“Sun Hopes For Better Storage with Honeycomb”, by S. Shankland, CNET_News.com, Nov. 28, 2005

“Sun's Honeycomb Hopes to Sweeten Storage”, by C. Boulton, Enterprise Jan. 5, 2005

“Honeycomb to Sweeten SUN NAS line”, by R. McMillan, TechWorld, Dec 23, 2004

“SUN Punches Data Archiving Envelope With Honeycomb”, by K. Schwartz, Jan. 4, 2005

“Honeycomb to Sweeten SUN NAS Line”, Computerworld, Dec. 23, 2004
HP Inc. Reference Information Storage System (RISS) as discussed in the references:

HP StorageWorks Reference Information Storage System

The systems disclosed by the above documents may adopt very different architectures from each other. For example, these systems may not have the conventional storage interfaces like FC, NFS/CIFS. Or, even if they have conventional storage interfaces, the interfaces do not work together in a manner to manage metadata. Thus, these systems require users to introduce new architectures, and as a result, the users' storage management costs increase. Also, there may be some risks and development costs for vendors to implement them.

### SUMMARY OF THE INVENTION

The present invention provides a method and apparatus for configuring a storage system to store and manage unstructured data.

Specifically the present invention provides a storage system for storing and managing unstructured data and associated metadata which describes attributes of said unstructured data. According to the present invention the storage system includes a plurality of storage areas for storing the unstructured data and metadata, wherein the metadata includes pointer information which identifies a location of unstructured data corresponding to the metadata, a server that manages the metadata, and a plurality of input/output (I/O) processing modules corresponding to the storage areas.

Further according to the present invention each I/O processing module processes commands from a host including commands requesting access to the unstructured data of a corresponding storage area. Also, each I/O processing module includes a client which communicates with the server to process the metadata when a command being processed by the I/O processing module affects the metadata of the unstructured data stored in the corresponding storage area.

As per the present invention the server could, for example, be a Database Management System (DBMS) or a Database Server (DB) server and the clients could, for example, be Database (DB) clients. Each client can operate to input, modify or delete metadata based on management commands from the host. The clients can also detect an I/O process that affects metadata (e.g. data movement or deletion) and reflect the result to the metadata. Further, the clients can retrieve unstructured data with specific metadata conditions and provide access methods and permissions to requesters such as the host or the other I/O processing modules.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto, wherein in the following brief description of the drawings:

FIG. 1 illustrates a logical system architecture of the storage system implementing the storing and managing of metadata according to an embodiment of the present invention;

FIG. 2 illustrates an example of a hardware architecture of the storage system implementing In band management of metadata according to an embodiment of the present invention;

FIG. 3 illustrates an example of a hardware configuration of Internet Protocol (IP) Interface Adapter like the NFS/CIFS Adapter 102 and the DB Adapter 103 according to an embodiment of the present invention;

FIG. 4 is a diagram for explaining a Metadata Table according to an embodiment of the present invention;

FIG. 5 is a flowchart of the steps performed by the storage system to implement a process of managing metadata using a metadata management program according to an embodiment of the present invention;

FIG. 6 is a flowchart of the steps performed by the storage system when the data management functions implemented by the storage system affect metadata according to an embodiment of the present invention;

FIG. 7 illustrates an example of a hardware architecture of the storage system implementing Out of band management of metadata according to an embodiment of the present invention;

FIG. 8 illustrates an example of a hardware architecture of the storage system implementing the storing and management of metadata in a remote copy system according to an embodiment of the present invention; and

FIG. 9 illustrates another example of the storage system architecture implementing the storing and managing of metadata according to another embodiment of the present invention.

### DETAILED DESCRIPTION OF THE INVENTION

The present invention as will be described in greater detail below provides an apparatus, method and computer program, particularly, for example, a method, apparatus and computer program for configuring a storage system to store and manage unstructured data. The present invention provides various embodiments as described below. However it should be noted that the present invention is not limited to the embodiments described herein, but could extend to other embodiments as would be known or as would become known to those skilled in the art.

### 1. FIRST EMBODIMENT

1.1 System Architecture

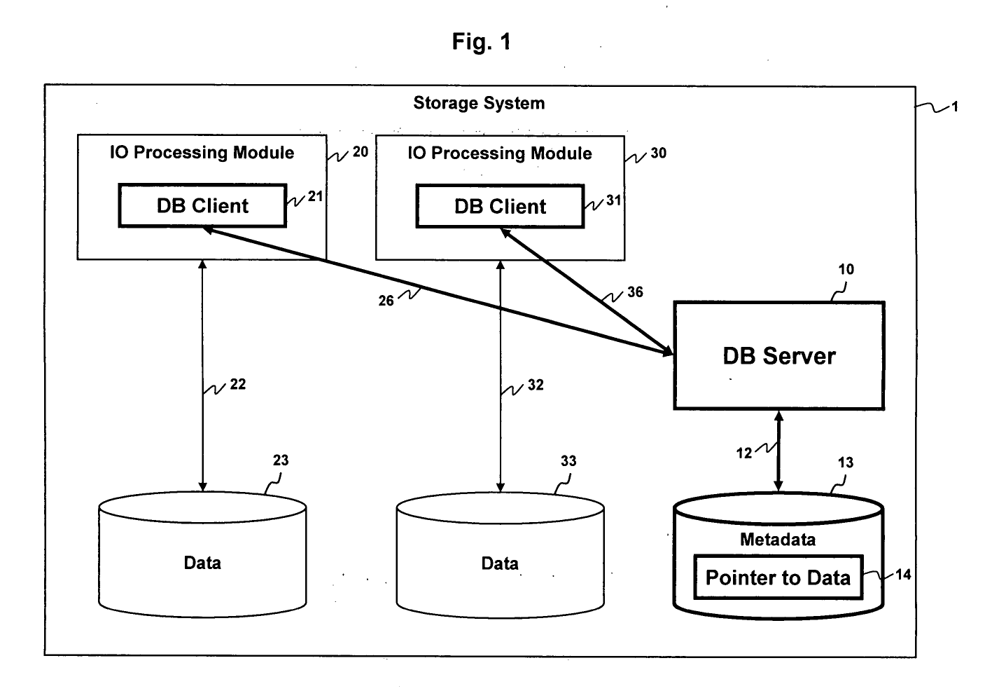

FIG. 1 illustrates a logical system architecture of the first embodiment according to the present invention. The present invention provides a storage system 1 for storing and managing unstructured data and associated metadata which describes attributes of the unstructured data. According to the present invention the storage system 1 includes a plurality of storage areas or logical volumes 23, 33, 13 for storing the unstructured data, for example, in logical volumes 23 and 33 and metadata, for example, in logical volume 13. As per FIG. 1 the metadata includes pointer information or data 14 which identifies a location of unstructured data in logical volumes 23 and 33 corresponding to the metadata. A server 10 is provided that manages the metadata. The storage system 1 as per FIG. 1 includes a plurality of input/output (I/O) processing modules 20 and 30 corresponding to the logical volumes 23 and 33.

Further according to the present invention each I/O processing module 20, 30 processes commands from a host including commands requesting access to the unstructured data of a corresponding logical volume 23, 33. Also, each I/O processing module 20, 30 includes a client 21, 31 which communicates with the server 10 to process the metadata when a command being processed by the I/O processing module 20, 30 affects the metadata of the unstructured data stored in the corresponding storage area.

The I/O processing modules 20, 30 of the storage system 1 interfaces to hosts (not shown in the figure). Each of the I/O processing modules can adopt one of the file based or block based protocols, such as NFS, CIFS, Fibre Channel, and Small Computer System Interface (SCSI). I/O requests from the hosts are processed in I/O processing modules 20 and 30 in general. Based on the processes performed by the I/O processing modules 20, 30 data is read from or written into logical volumes 23 and 33 through logical paths 22 and 32. It should be noted that although FIG. 1 illustrates the storage system as having two logical volumes, the number of resources is not limited to two, but can be any number based on product specifications.

In this embodiment, the server of storage system 1 could, for example, be a Database Management System (DBMS) or DB server 10, which manages metadata in logical volume 13 through a logical path 12. It is a unique feature in this embodiment that the metadata contains the pointer information or data 14 which identifies a location of unstructured data in logical volumes 23 and 33 corresponding to the metadata. Thus, the pointer information 14 sets a relationship between unstructured data and metadata.

It is a further unique feature in this embodiment that the I/O Processing Modules 20 and 30 contain DB clients 21 and 31, which communicate with the DB server 10 through logical paths 26 and 36.

1.2 Hardware Architecture

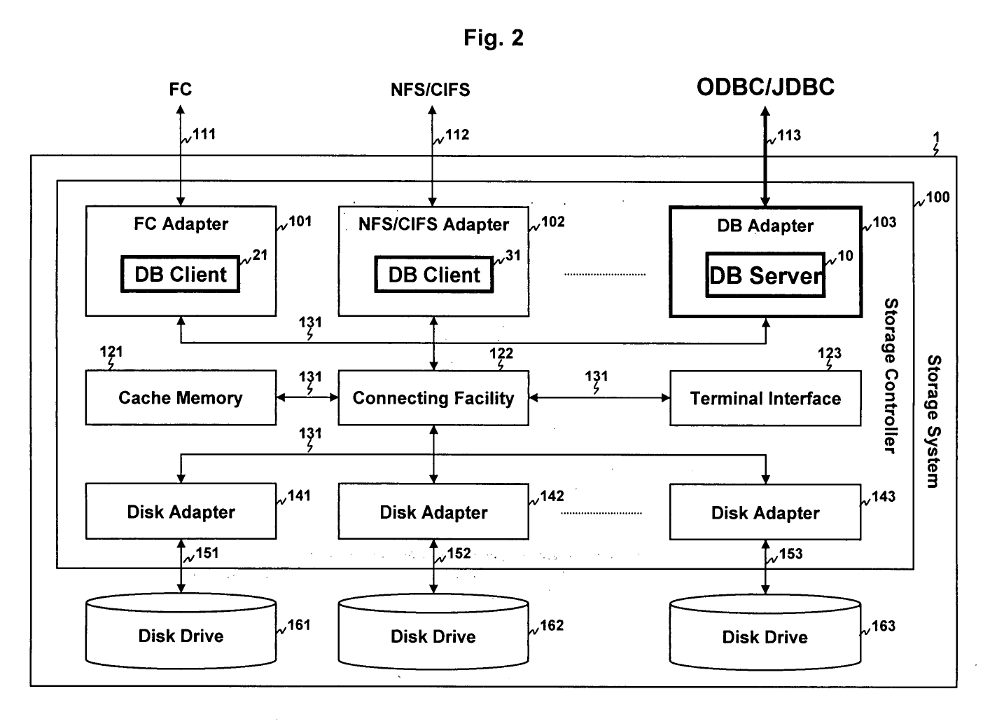

FIG. 2 illustrates an example of the hardware architecture of realizing the storage system 1 in this embodiment.

The storage system 1 includes a storage controller 100 for controlling operation of the storage system and multiple disk drives 161, 162 and 163 for storing data. The number of the disk drives is not limited to three. The storage controller 100 further includes a plurality of I/O channel adapters 101, 102 and 103 for interfacing to external apparatus such as hosts, a cache memory 121 for temporarily storing data, a terminal interface 123 for coupling with another apparatus, a plurality of disk adapters 141, 142 and 143 for interfacing to the disk drives 161,162 and 163 and a connecting facility 122. Each component is connected to each other through an internal network 131 and the connecting facility 122. Examples of types of networks for internal network 131 are Fibre Channel (FC) Network, PCI, InfiniBand, etc.

The Terminal Interface 123 operates as an interface (IF) to an external controller or a service processor, which may manage the storage controller 100, send commands and receive data through the Terminal Interface 123. The disk adapters 141, 142 and 143 also work as IF to disk drives 161, 162 and 163 via FC cable, SCSI cable or any other disk I/O cables 151, 152 and 153. Each adapter 141, 142 and 143 contains a processor to manage I/O processes. The number of disk adapters 141,142 and 143 is not limited to three.

In this embodiment, the channel adapters 101, 102 and 103 are prepared at least one of the I/O protocols that the storage system 1 supports. Thus, the channel adapters could, for example, be one of a FC adapter 101, a NFS/CIFS adapter 102 and DB adapter 103. They may communicate with hosts through FC cable 111, Ethernet Cable 112 and Ethernet Cable 113 respectively. There may be several types of adapters of each protocol in the storage system 1.

It is a unique feature in this embodiment that the storage system 1 contains the DB adapter 103, which includes the DB server 10. The DB server may provide general DB access IF like ODBC or JDBC to outside of the storage system 1. The hosts can access to the storage system 1 through those ODBC or JDBC interface. The DB server 10 may be implemented as software program on the DB adapter 103.

Also, it is a unique feature in this embodiment that the FC adapter 101 and the NFS/CIFS adapter 102 contain the DB clients 21 and 31, which may be implemented as software program on the adapters. In another embodiment, the DB Clients and DB Server 10 may reside in one of the disk adapters 141,142 or 143 or any other component in the storage system 1 which has a program executing capability.

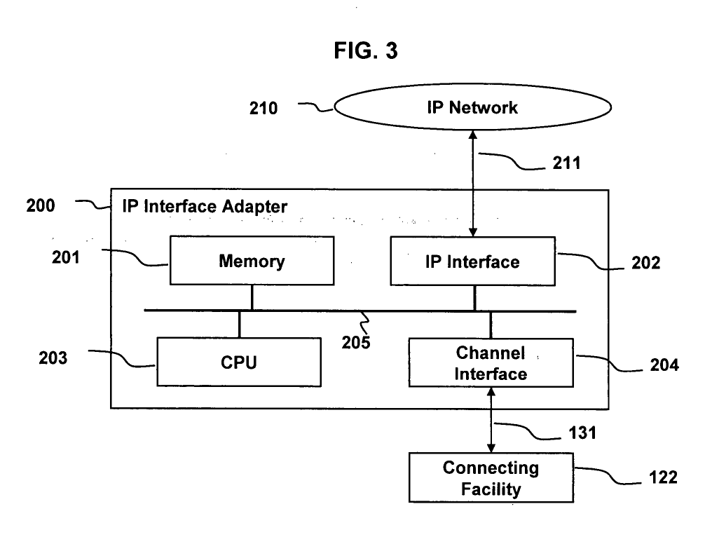

FIG. 3 illustrates an example of the hardware configuration of an IP Interface adapter 200 which may be a base of the NFS/CIFS adapter 102 or the DB Adapter 103.

The IP Interface adapter 200 includes a Central Processing Unit (CPU) 203, memory 201, an IP Interface 202, channel interface 204 and possibly other components not shown. Each component is connected through an internal bus network 205, like PCI. A network cable 211 which connects the IP Interface adapter to an IP network 210 may be an Ethernet, wireless or any other IP network cable sufficient to form a good connection. The channel interface 204 communicates with other components on the storage controller 1 through the connecting facility 122.

Each component of the adapter is managed by an Operating System or any other software (not shown in the figure) running on CPU 203. The IP Interface adapter 200 could, for example, be implemented using general purpose components. For example, the CPU 203 can be Intel® based, and the Operating System (OS) can be Linux based.

NFS/CIFS protocols can, for example, be handled by software programs, loaded into the memory 201 of the IP Interface adapter 200 and executed on the CPU 203.

The DB server 10 can, for example, be implemented as software programs, loaded into the memory 201 of the IP Interface adapter 200 and executed on the CPU 203. The DB server 10 can be implemented using a general purpose Relational Database System (RDB) running on a Linux OS and Intel® based CPU, like PostgreSQL, MySQL and any others. In this case, the metadata can be realized as database tables within the RDB.

In another embodiment, at least two DB adapters can reside in the storage system 1 and configure a cluster to improve performance or increase reliability.

Also, the DB client 31 along with other I/O process may be implemented as software programs, loaded into the memory 201 of the IP Interface adapter 200 and executed on the CPU 203. The DB client 31 may be implemented using a general purpose RDB client running on a Linux OS and Intel® based CPU, like JDBC™/ODBC client and any others.

The communication path between the DB server 10 and the DB client 31 can be achieved through the internal network 131 and the connecting facility 122. A protocol used for the communications can be Transfer Control Protocol (TCP)/Internet Protocol (IP). For example, if the network 131 is FC based, IP over FC protocol needs to be implemented.

A hardware configuration of the FC adapter 101 is not shown in the figures. However, it is basically similar to the IP Interface adapter 200 as illustrated in FIG. 3. The FC 101 adapter contains a CPU to execute FC process including the DB client 21. Communications between the DB server 10 and the DB client 31 can be achieved through the internal network 131 and the connecting facility 122.

1.3 Data Structure of Metadata

Metadata, as described above, defines attributes or characteristics of the unstructured data stored in the storage system 1. The metadata is managed by the DB server 10, and the metadata itself is also stored in the storage system 1. The present invention allows the data structure or a schema of the metadata to be configurable by users like administrators. According to the present invention the schema of the metadata is configured to include the pointer (information or data) 14 to the location of unstructured data in the storage system to which it is related. Because descriptions of the location or address of the unstructured data are different among different I/O protocols that may be supported by the storage system 1, the schema may also include information related to the descriptions.

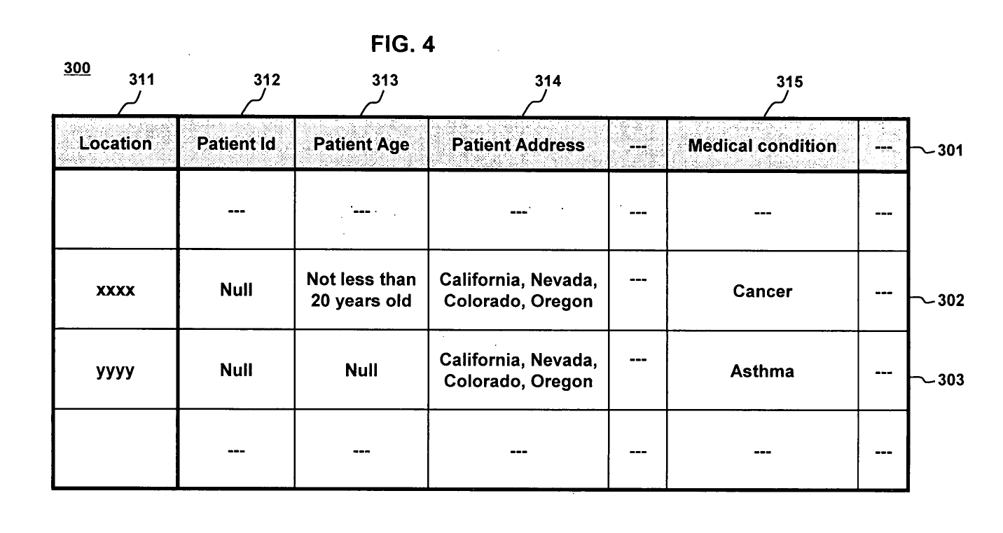

FIG. 4 shows an example of the structure of a Metadata Table 300 having a plurality of entries or rows. The Metadata Table 300 is used to identify a location of unstructured data to which it is related and indicate attributes or characteristics of the data. Specifically FIG. 4 describes an example of the metadata schema used with respect unstructured data of medical images. For example, the fist row of the table 301 indicates the structure of the schema as may be defined by the administrative users. This structure as defined by the administrative users according to the present invention will include, for example, location or address information (Pointer) indicating the location or address in the storage system 1 of the unstructured data to which the metadata is related. In FIG. 4 the pointer is set forth in column 311.

Regarding the pointer in column 311 if, for example, the medical images are managed under block based addressing, then the location or address information may include a volume number, a Logical Block Address (LBA) and data size. The location may also be called as an Extent, which describes an arbitrary space in a volume, and the location or address information may include information of an Extent location (e.g. Extent ID). For another embodiment if, for example, the medical images are managed under file based addressing, then the location or address information may include information of a file location. In yet another embodiment, a description about the location and address information may be added as an item of metadata to distinguish which addressing method is to be used to locate the data to which the metadata is related.

As per FIG. 4 columns 312 through 315 describe metadata or attribute data of the medical images. These are just examples, and configurable by the administrators. Rows 302 and 303 are examples metadata of particular medical images. These metadata may be used for data searching, data classification, data protection, data repurposing, data versioning, data integration, etc.

According to the present invention there may be several types of metadata in the storage system 1. In other words, there may be several metadata tables in the database. Each metadata table may be selected by the hosts implicitly by specifying the table name, or explicitly by providing conditions specifying the table.

Also, according to the present invention there may be an index or a reverse pointer from data to metadata. The index or reverse pointer is useful for the DB Server to find appropriate records quickly. These indexes or pointers are also updated when the metadata is modified.

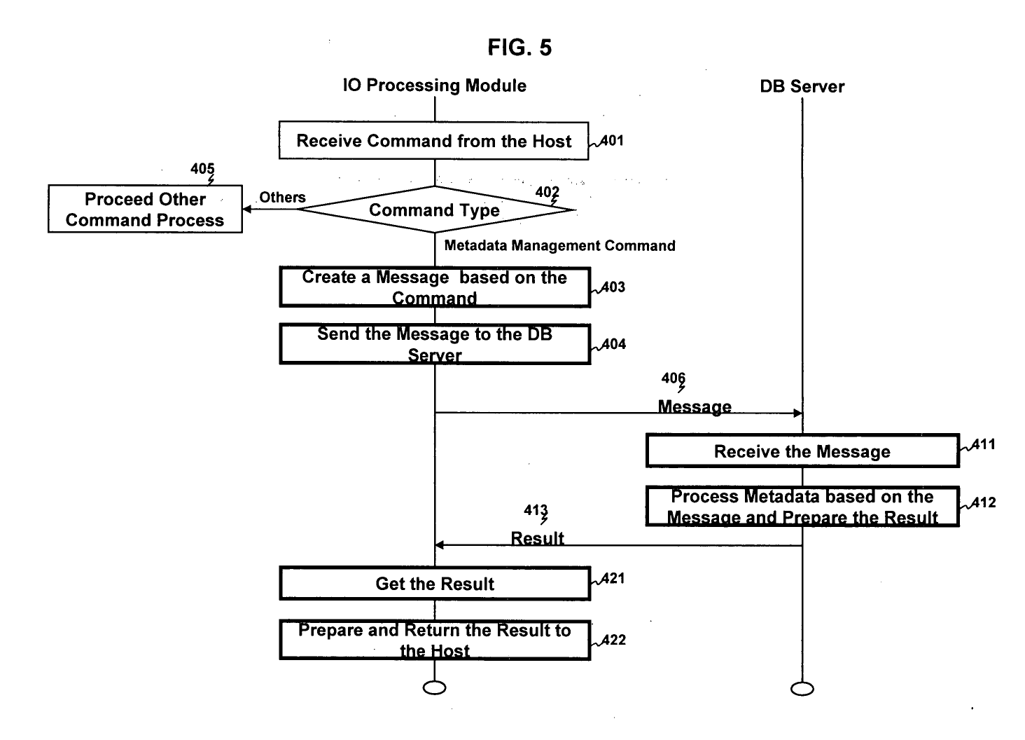

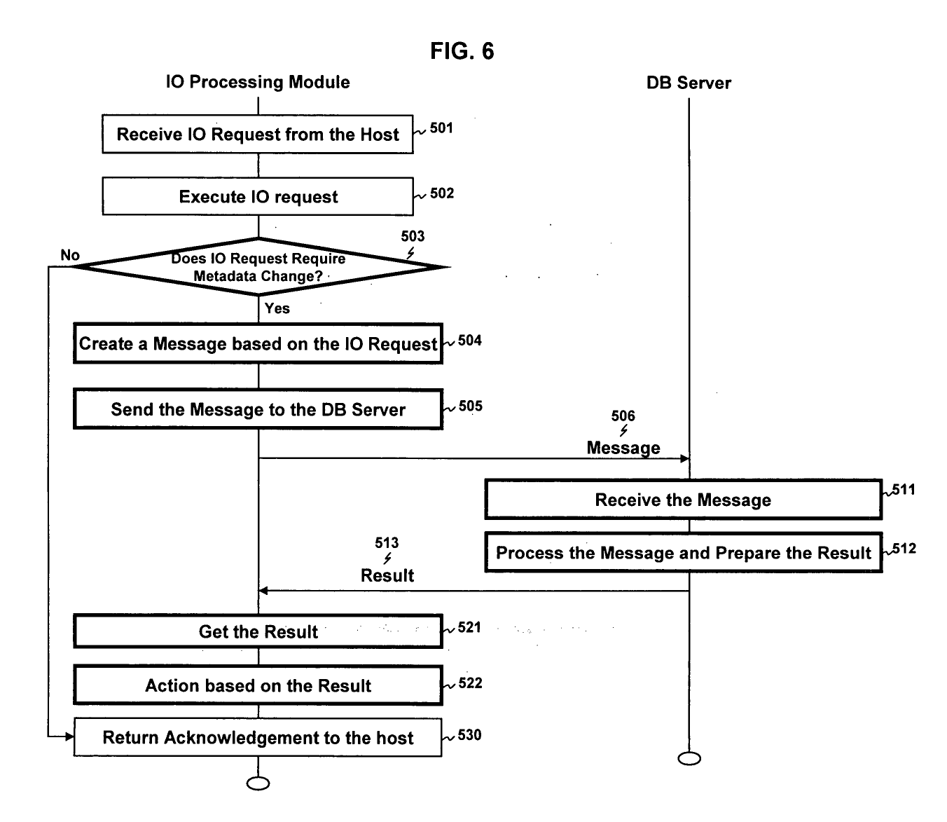

1.4 Metadata Management There are two ways to manage metadata as illustrated in FIGS. 5 and 6.

1.4.1 Metadata Management Program

In general, the storage system 1 provides a storage management IF such as Command Line Interface (CLI), Application Program Interface (API), Graphical User Interface (GUI) and others. The IF may be achieved through I/O adapters 101-103, or terminal Interface 123 as illustrated in FIG. 2. Providing the storage management IF through the I/O adapters is sometimes called an In band IF, and providing the storage management IF through the terminal Interface 123 is called an Out of band IF. An example of an In band IF is the Command Control Interface (CCI) in Hitachi storage products. An example of an Out of band IF is the HiCommand API in Hitachi storage products.

According to the present invention the metadata management IF can be provided as a part of the storage management IF. For an embodiment where the metadata management IF is executed In band, the FC Adapter 101, the NFS/CIFS Adapter 102 and any other Channel Adapters are configured to contain metadata management programs, which include the DB client 21 and 31, and process metadata as the metadata management IF.

In another embodiment, where the Channel Adapters do not have the capability to process metadata management programs, the Channel Adapters pass the metadata management command to an appropriate component that has the capability to process it. For example, Disk Adapters or any other components that have CPU may have the capability.

In another embodiment, where the metadata management IF is executed Out of band, the terminal Interface is configured to receive a metadata management command and pass it on to an appropriate component that has the capability to process it.

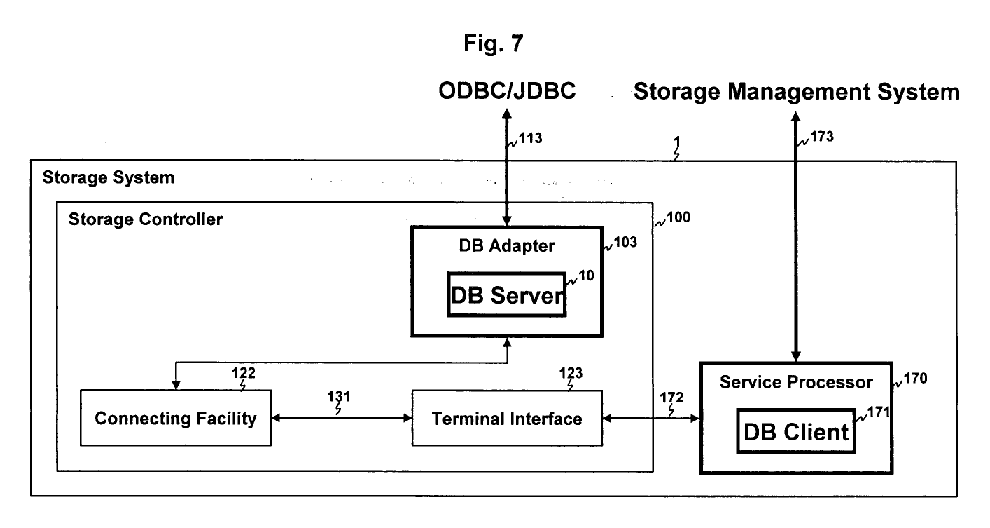

FIG. 7 illustrates the hardware architecture of the storage system 1 implementing Out-of-band management of metadata according to the present invention. The storage system 1 as illustrated in FIG. 7 has many of the same elements as the storage system 1 illustrated in FIG. 2 with the exception of a service processor 170 containing a DB client 171, a network 172 connecting the service processor 170 to the terminal interface 123 and a network 173 which connects the service processor 170 to apparatus external of the storage system 1 to, for example, a storage management system.

The DB client 171 can be implemented as a software program on the service processor 170. The network 172 connected between the service processor 170 and the terminal interface 123 can be a serial IF. The network 173 connected between the service processor 170 and the storage management system external of the storage system 1 can an IP network.

According to the present invention query requests from the storage management system and the results of the query requests are communicated through the DB client 171, the terminal interface 123, the connecting facility 122 and the DB server 10.

The metadata management IF requires a specific metadata management communication language. Examples of basic function types to be included in the metadata management communication language include (1) defining metadata schema: add or modify a metadata table; (2) inserting metadata: add an entry or entries into the metadata table; (3) deleting metadata: delete an entry or entries in the metadata table; (4) updating metadata: update metadata in an entry or entries; (5) finding data under a specific metadata condition; and (6) droping metadata schema: delete a metadata table.

The easiest way to implement the metadata management communication language is to use or emulate an existing communication language like Sequential Query Language (SQL). In this embodiment, it is supposed that a subset of SQL is used as the metadata management communication language. How much of the subset is used or how many modification is made to SQL may depend on each implementation. In order to distinguish queries using the metadata management communication language from other storage management IF communications, a prefix like “SQL”, may be added to a statement. Thus, the metadata management program needs to only to select statements which include “SQL” at its front and process the other part as a metadata management statement from the Host.

In another embodiment, Extended Attributes in File System may be utilized as the metadata management communication language. For example, BSD provides XATTR family of functions to manage the Extended Attributes in the file system. A discussion of Extended Attributes can be found in the article “Extended Attributes”, by J. Siracusa, ArcsTechnica website, Apr. 28, 2005 at http://arstechnica.com/reviews/os/macosx-10.4.ars/7?84394. FIG. 5 shows a process flow of the Metadata Management Program in the IO Processing Module and its communication process with the DB Server.

FIGS. 5 and 6 each illustrate various processes performed as a result of execution of the functions of the metadata management program. The flow chart illustrated in each of FIGS. 5 and 6 can, for example, be implemented by hardware and/or software. If implemented by software each of the steps of the flow chart can, for example, correspond to computer program code or instructions executed by a processor.

The flow of the process upon execution of the metadata management program illustrated in FIG. 5 is as follows.

An I/O processing module 20, 30 receives a command from a host. The command may be one of many types of management commands such as volume management, replication management (Step 401). The I/O processing module 20, 30 analyzes the command to determine its type and selects an appropriate process for processing the command (Step 402). If the command is determined to be a command other than a metadata management command, then the process proceeds to Step 405 where the appropriate process is implemented. If the command is determined to be a metadata management command (e.g. there is “SQL” word at its front), then the process proceeds to Step 403.

Following Step 402, the program creates a message which will be sent to the DB server 10, based on the received command (Step 403). The message may be a JDBC/ODBC statement including SQL. The method used to create a message is dependent upon the specific implementation. Thereafter, the program sends the message 406 to the DB server 10 (Step 404).

The DB server 10 receives the message 406 (Step 411) and then processes the metadata according to the message, prepares a result 413 of the processing, and returns the result 413 of the processing to the DB client 21, 31 (Step 412). The DB client 21, 31 receives the result 413 of the processing (Step 421), prepares the result 413 of the processing for the host and returns the result 413 of the processing to the host (Step 422).

In another embodiment, the result 413 returned to the host can, for example, specify particular data, and the I/O processing module 20, 30 can provide the access method and permission to the host.

1.4.2 Data Management Functions that Affect Metadata

In general, a storage system can execute in response to selected commands various data management functions such as data copy, migration, deletion, etc. Also, when executing such commands management granularity, such as a unit of data or a set of data (e.g. volume) upon which the process requested by the command is to be performed, differs depending on their implementation. Within these general data management functions there are some that affect metadata. Examples of data management functions that affect metadata are listed in the following Table 1. The functions listed in Table 1 particularly include those that affect the pointer 14 which points to data related to the unstructured data.

As per Table 1 these data management functions include Move, In-system Copy, Remote Copy and Delete. According to the present invention certain messages are generated by the DB Client 21, 31 of the I/O processing module 20, 30, when commands including the Move, In-system Copy, Remote Copy and Delete data management functions are encountered, to cause the DB server 10 to perform metadata management operations on the metadata. The processings that are conducted when commands including these data management functions are encountered are described with respect to the flowchart illustrated in FIG. 6.

TABLE 1
Storage Functions that affect metadata and metadata management

| Data | | |
|---|---|---|
| Management | | |
| Functions | Granularity | Metadata management |
| Move | Data (e.g. a File or an | The module sends to the DB |
| | Extent) | Server a message requesting |
| | | to change the data's location |
| | | within the metadata. |
| | A set of data (e.g. a | The module sends to the DB |
| | directory or a Volume) | Server a message requesting |
| | | to change individual locations |
| | | of all data in the set within the |
| | | metadata. |
| In-system Copy | Data (e.g. a File or an | Described in Sec 1.4.3 |
| | Extent) | |
| | A set of data (e.g. a | Described in Sec 1.4.3 |
| | directory or a Volume) | |
| Remote Copy | Data (e.g. a File or an | Described in Sec 1.4.4 |
| | Extent) | |
| | A set of data (e.g. a | Described in Sec 1.4.4 |
| | directory or a Volume) | |
| Delete | Data (e.g. a File or an | The module sends to the DB |
| | Extent) | Server a message requesting |
| | | to delete the entry of the data |
| | | within the metadata. |
| | A set of data (e.g. a | The module sends to the DB |
| | directory or a Volume) | Server a message requesting |
| | | to delete individual entries of all |
| | | data in the set within the |
| | | metadata. |

According to another embodiment, metadata can include access logs to the unstructured data such that every time the I/O processing module 20, 30 detects an access to predefined data, the I/O processing module 20, 30 sends an access count or any other access information (e.g. who is accessing which information and executing what commands) to the DB server 10. The access information may be used for auditing or other purposes in future.

The data management functions listed in Table 1 can be issued by hosts through an In-Band IF or an Out-of-Band IF. Also, the data management functions can be automatically executed within the storage system 1 based on pre-defined rules or schedules. In either case, the storage system 1 checks if a requested function requires metadata change or not.

FIG. 6 illustrates a flow of the process in the I/O Processing Module 20, 30 and its communication process with the DB server 10, when a host issues a command including a data management function through an In-Band IF. Other cases, including Out-of-Band IF, Automation in the system, etc. are similar to the process illustrated in FIG. 6 with the exception of Step 501. In these other cases rather than receiving the command in the I/O processing module 20, 30, the commands can be received, for example, via the service processor 170 as illustrated in FIG. 7.

The flow of the process to determine whether a command includes a data management function which requires a change in metadata as illustrated in FIG. 6 is as follows.

The I/O processing module 20, 30 receives a command from a host, wherein the command can be one of many types of commands including commands such as Move, In-system Copy, Remote Copy, Delete, etc as per Table 1 (Step 501). Then the process proceeds to Step 502 where the I/O process is performed

The I/O processing module 20, 30 analyzes the command to determine whether the command requires a metadata change, namely whether the command affects, requires a change in, metadata (Step 503). If the command is determined to be a command other than one that affects metadata, then the process proceeds to Step 530 where an acknowledgement is returned to the host. If the command is determined to be a command that affects, requires a change in, metadata, then the process proceeds to Step 504.

Following the Step 503, based on predefined rules and the received command, the I/O processing module 20, 30 selects specific I/O requests and creates a message to be sent to the DB server 10 (Step 504). The method used to create a message is dependent upon the specific implementation.

For example, for the Move function with a single data (e.g. a file or an extent) as a target if the target data has metadata managed in the DB Server 10, then the message requests the DB server 10 to change the pointer indicating the location of the data to the new one where the data is moved. In order to determine quickly that the target data has metadata managed in the DB Server 10, there may be an index table identifying existence of metadata and its location if it exists for each single data.

For the Move function with a set of data (e.g. a directory or a volume) as a target if the target set of data contains data that has metadata managed in the DB Server 10, then the message requests the DB server 10 to change the respective pointers indicating the locations of each of the items to the new ones where each of the items is moved.

For the In-system Copy and the Remote Copy functions the messages created will be discussed below in sections 1.4.3 and 1.4.4, respectively.

For the Delete function with a single data (e.g. a file or an extent) as a target if the target data has metadata managed in the DB Server 10, then the message requests the DB server 10 to delete the entry of metadata including the pointer related to the data to be deleted.

For the Delete function with a set of data (e.g. a directory or a volume) as a target if the target set of data contains data that has metadata managed in the DB Server 10, then the message requests the DB server 10 to delete each entry of metadata including its pointer related to the data to be deleted.

After the message has been created the message 506 is then sent to the DB server 10 (Step 505).

The DB server 10 receives the message 506 (Step 511), and processes the metadata as per the message according to its request, prepares a result 513 of the processing, and returns the result 513 of the processing to the DB client 21, 31 (Step 512). The DB client 21, 31 receives the result 513 of the processing (Step 521), and takes action based on the result (Step 522) of the processing. Thereafter, the process proceeds to Step 530.

It should be noted that if the result 513 from the DB server 10 contains errors, the I/O processing module 20, 30 may return an I/O error to the host.

FIG. 6 illustrates a synchronous manner in which the metadata management is executed before the I/O process as requested by the command has been performed. However, according to another embodiment an asynchronous manner in which metadata management is executed independent of performing the I/O process can be used.

1.4.3 In-system Copy

Sometimes, In-system Copy is called In-System Replication or Mirroring. Examples of In-system Copy in the Hitachi storage systems are ShadowImage™ and QuickShadow™.

When a command includes an In-system Copy functions the message created by the I/O processing module 20, 30 depends on four different cases describe as follows:

Case 1:

The Copy is conducted once, and no update copy is executed (so called Point in Time Copy).

In this case, the metadata is also copied once, and no update is propagated to the copied metadata. The process is as follows:

For copied data or each data in a set of copied data:

a) The I/O processing module 20, 30 creates a message to be sent the DB Server 10 requesting the DB server 10 to create a new entry of metadata,

b) Copy the metadata from the original, and

c) Set the copied data's location within the metadata.

Case 2:

Update copy, but the metadata is copied once.

In this case, the metadata is also copied, but not updated even if the original metadata is updated. The process is the same as the Case 1 described above, namely the same type of message is created by the I/O processing module 20, 30 and sent to the DB Server 10.

Case 3:

Update copy, and the metadata also needs to be updated when the original metadata is updated.

In this case, the metadata is not necessarily copied, but the metadata can be modified to refer to the original data and the copied data. In other words, the pointer in column 311 of the Metadata Table 300 is modified to contain multiple locations that point to the original and the copied data. Thus, in this case a message is sent from the I/O processing module 20, 30 to the DB server 10 requesting that the pointer of the metadata be modified to refer to the original data and the copied data.

Case 4:

Point in Time Copy or Update Copy, but the metadata is not copied.

In this case, the metadata may not be modified at all, or a new entry with blank may be assigned, which may be filled in later, in the metadata.

One of those cases may be specified by commands or options associated with the In-system Copy functions.

1.4.4 Remote Copy

Sometimes, Remote Copy is called Remote Replication or Mirroring. Examples of Remote Copy in the Hitachi storage systems are TrueCopy™ and Hitachi Universal Replicator.

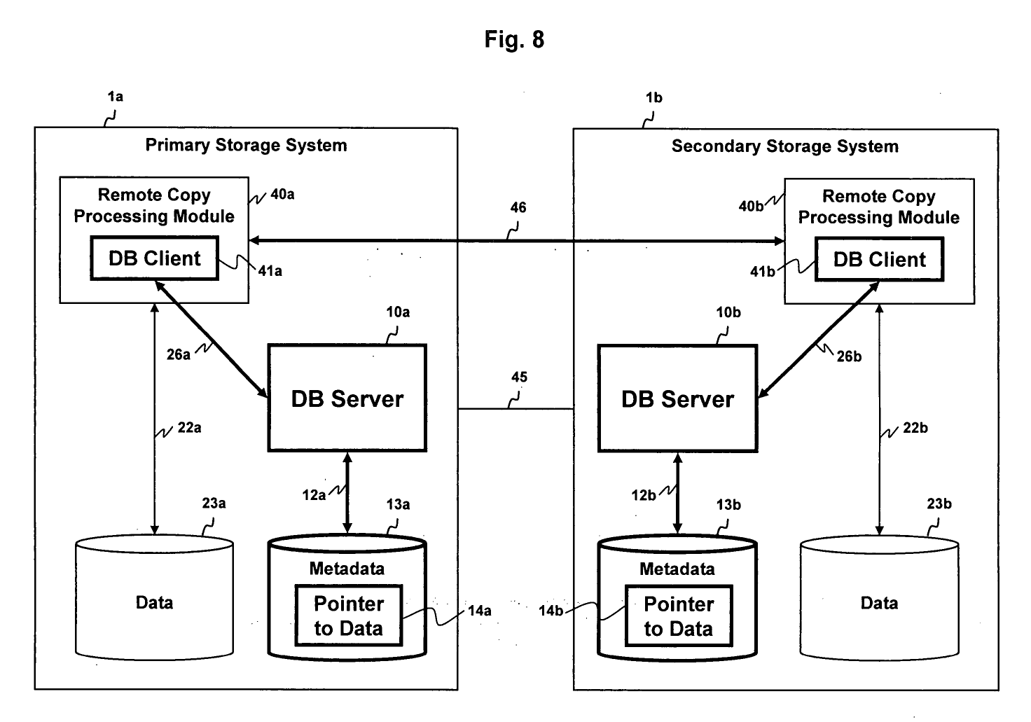

FIG. 8 illustrates the hardware architecture of a storage system having a primary storage system 1a and a secondary storage system 1b implementing remote copy embedding of database management functions according to the present invention.

The primary and secondary storage systems 1a and 1b each includes a remote copy processing module 40a, b containing a DB client 41a, b. The remote copy processing module 40a, b may be implemented on one of I/O processing modules 20, 30, more particularly on one of the adapters 101, 102, or any other processing modules including disk adapters 141-143 as shown in FIG. 2. In this regard the DB client 41a, b functions the same as the DB clients 21, 31 as shown in FIG. 2.

Each storage system further includes a DB server 10a, b, storage areas or logical volumes 23a, b and 13a, b for storing the unstructured data, for example, in logical volume 23a, b and metadata, for example, in logical volume 13a, b. As per FIG. 8 the metadata includes pointer information or data 14a, b which identifies a location of unstructured data in logical volume 23a, b corresponding to the metadata. The DB server 10a, b is connected to the logical volume 13a, b by a logical connection 12a, b and to the DB client 41 a, b by a logical connection 26a, b. The remote copy processing module is connected to the logical volume 23a, b by a logical connection 22a, b. These logical connections may be realized by the same manner as described in FIG. 2 and 3.

A network 45 interconnects the primary and secondary storage systems 1a, and b to each other. The network 45 can, for example, be a wide area storage network used for ordinal remote copy operations. A logical path 46 is provided to connect the remote copy processing modules 40a, b to each other. The logical path 46 can be based on a specific protocol of remote copy.

When a command includes a Remote Copy function the message created by the remote copy processing module 40a, b depends on four different cases describe as follows:

Case 1:

The Copy is conducted once, and no update copy is executed (so called Point in Time Copy).

The process proceeds as follows:

For copied data or each data in a set of copied data:

a) Before sending data to the remote copy processing module 40b in the secondary storage system, the remote copy processing module 40a in the primary storage system sends a message to the DB server 10a inquiring about the metadata associated with the data to be copied.

b) Then, the remote copy processing module 40a sends metadata as well as the unstructured data to the remote copy processing module 40b.

c) When the remote copy processing module 40b receives the unstructured data and the metadata, the remote copy processing module 40b saves the data to an appropriate place in volume 23b, and then sends a message to the DB server 10b requesting that the metadata be stored along with a pointer (location information) 14b of the unstructured data in the volume 13b.

Case 2:

Update copy, but the metadata is copied once.

The process is the same as the Case 1 described above, namely the same type of messages are created by remote copy processing modules 40a, b and sent to the DB servers 100a, b.

Case 3:

Update copy, and the metadata also needs to be updated when the original metadata is updated.

In one embodiment, any update to the original metadata is also copied to the metadata in the secondary storage system 1b. The metadata table in the primary storage system la may contain a column providing information such as information indicating the location of the copy of the metadata stored in the secondary storage system 1b. If an entry in the metadata stored in the primary storage system 1a is updated, then the update information is also sent to the copy of the metadata at the indicated location in the secondary storage system 1b.

In another embodiment, a volume containing the metadata table itself is replicated to the secondary storage using the ordinal volume based remote copy method. In this case, the data volume and the metadata volume must be in the same consistency group. In other words, time consistency between the data volume and the metadata volume at the secondary storage need to be maintained.

Case 4:

Point in Time Copy or Update Copy, but the metadata is not copied.

In this case, the metadata 13b may not be modified at all, or a new entry with blank may be assigned, which may be filled in later, in the metadata 13b.

One of those cases may be specified by commands or options associated with the Remote Copy functions.

Thus, as describe above the present invention provides a method and apparatus for configuring a storage system to store and manage unstructured data using metadata. Specifically, according to the present invention a storage system is provides for storing and managing unstructured data and associated metadata which describes attributes of the unstructured data. According to the present invention the storage system includes a plurality of storage areas or volumes for storing the unstructured data and the metadata, wherein the metadata includes pointer information which identifies a location of unstructured data corresponding to the metadata in the volumes, a DB server that manages the metadata, and a plurality of I/O processing modules corresponding to the storage areas or volumes.

Further, as described above according to the present invention each I/O processing module processes commands from a host including commands requesting access to the unstructured data of a corresponding storage area. Also, each I/O processing module includes a DB client which communicates with the DB server to process the metadata when a command being processed by the I/0 processing module affects, requires a change in, the metadata of the unstructured data stored in the corresponding storage area.

1.5 Uses for the Invention

Metadata can be used for various purposes due to its feature of describing the attribute or characteristics of unstructured data. However, when the metadata is used to perform various functions the present invention provides a method and apparatus for managing and storing the metadata in a storage system that is normally used for storing structured data. Some examples of uses of metadata are as follows.

1) Data searching

Metadata contains data attributes, and the metadata are compared with specified attributes to find specific data.

2) Data classification

Data can be classified and reallocated into specific locations of volumes or particular volumes based on their attribute.

3) Data protection

There may be several Quality of Service (QoS) layers predefined to protect data. The QoS layers are automatically assigned to data based on their attributes using predefined rules or policies, and the QoS information for each data may be stored in the metadata as well.

4) Data repurposing

Data is specified by its attribute and reused for other purposes.

5) Data versioning

Metadata may contain version numbers, and the host can track its versioning.

These are just examples of the various uses of metadata, and there may be more use cases using the metadata in a storage system. For all of such uses the managing and storing of metadata according to the present invention becomes important.

### 2. SECOND EMBODIMENT

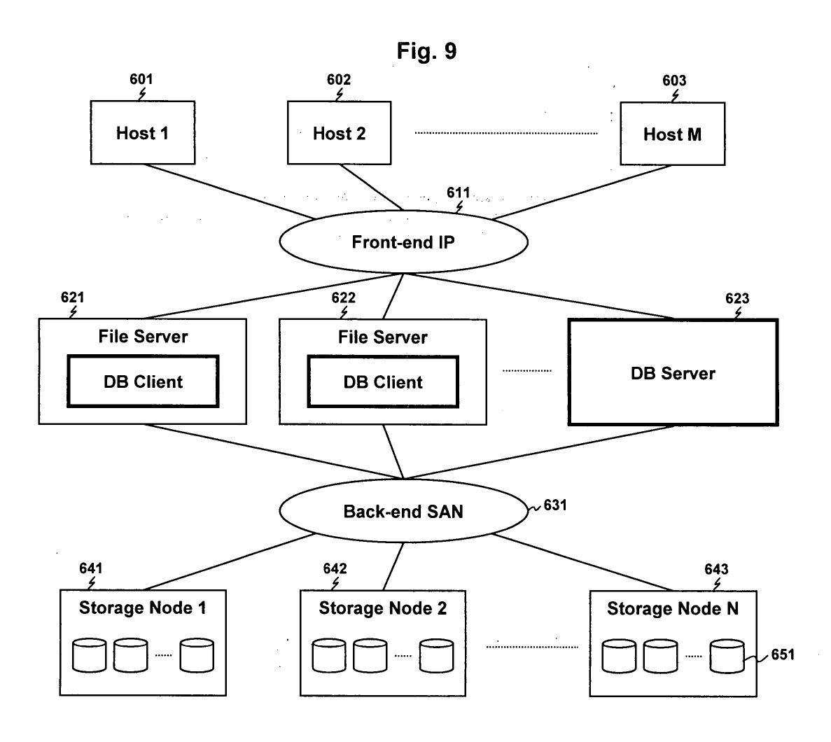

FIG. 9 illustrates another example of the storage system architecture implementing the storing and managing of metadata according to another embodiment of the present invention

File Servers 621, 622 and DB Server 623 share storage resources 641-643 (i.e. storage nodes) through a SAN 631. Examples of File Servers are NAS Gateways (or Head) and CAS Gateways (or Head). The number of DB Servers could, for example, be more than two.

Those servers include HBA (Host Bus Adapter) and are able to access the SAN 631. The storage nodes 641-643 have FC access. The servers and the nodes can be configured in a single cabinet.

The protocols described in FIG. 5 and 6 may be implemented through Front-end IP 611.

In another embodiment, there is provided a network storage controller or a storage virtualization system, which virtualizes storage nodes and provides virtual volumes across storage nodes to the servers, between the servers 621-623 and the storage nodes 641-643 (above the Back-end SAN 631). The virtualization as implemented by the network storage controller provides a single view of the storage nodes 641-643 to the servers 621-623 to simplify their management.

### 3. OTHER EMBODIMENTS

Other embodiments of the present invention are possible with the main object being the managing and storing of metadata data in a storage system. For example, another embodiment of the present invention can place the DB server 10 and its storage area or volume 13 external of the storage system 1 in another storage system which is accessible to the DB client 21, 32 via a network.

Many other such embodiments are possible that are presently known or will become known to those of ordinary skill in the art and still satisfy the basic intent of the invention, the managing and storing of metadata as encompassed by the claims.

While the invention has been described in terms of its preferred embodiments, it should be understood that numerous modifications may be made thereto without departing from the spirit and scope of the present invention. It is intended that all such modifications fall within the scope of the appended claims.

What is claimed is:

1. A storage system for storing and managing unstructured data and associated metadata which describes attributes of the unstructured data, said storage system comprising:
a plurality of storage areas for storing the unstructured data and metadata,
wherein the metadata includes pointer information which identifies a location of unstructured data corresponding to the metadata;
a server that manages the metadata; and
a plurality of input/output (I/O) processing modules corresponding to said storage areas,
wherein each I/O processing module processes commands from a host including commands requesting access to the unstructured data of a corresponding storage area, and
wherein each I/O processing module includes a client which communicates with said server to process the metadata when a command being processed by the I/O processing module affects the metadata of the unstructured data stored in the corresponding storage area.

2. A storage system according to claim 1, wherein each I/O processing module is one of a Fibre Channel (FC) adapter, a Network File System/Common Internet File System (NFS/CIFS) adapter and a Database (DB) adapter.

3. A storage system according to claim 1, wherein each I/O processing module contains a DB client as said client and said unstructured data is managed by a DB Management System (DBMS) as said server.

4. A storage system according to claim 3, wherein each I/O processing module is one of a Fibre Channel (FC) adapter and an Internet Protocol (IP) adapter and each of the DB clients is implemented as a software program executable by the corresponding adapter.

5. A storage system according to claim 1, wherein said server is a DB server which can reside in one of a plurality of adapters serving as an interface to disk drives containing said storage areas or an interface to hosts accessing to said storage system.

6. A storage system according to claim 5, wherein the one adapter upon which the DB server resides has a program executing capability for executing software implementing the DB server.

7. A storage system according to claim 5, wherein a data structure or a schema of the metadata is configurable by users of the storage system but at least includes the pointer information.

8. A storage system according to claim 7, wherein descriptions of the location of the unstructured data are different among different I/O protocols, the schema includes information related to the descriptions.

9. A storage system according to claim 1, wherein when the command being processed by the I/O processing module is a metadata management command that manages the metadata of the unstructured data, the I/O processing module creates a message to be sent to said server based on the command and sends the message to said server,
wherein said server upon receipt of the message, processes the metadata according to the message and returns a result of the processing to the I/O processing module, and
wherein the I/O processing module upon receipt of the result of the processing from said server, returns the result of the processing to the host.

10. A storage system according to claim 1, wherein when the command being processed by the I/O processing module is an I/O command having a data management function that affects the metadata of the unstructured data, the I/O processing module creates a message to be sent to said server based on the I/O command and sends the message to said server,
wherein said server upon receipt of the message, processes the metadata according to the message and returns a result of the processing to the I/O processing module, and
wherein the I/O processing module upon receipt of the result of the processing from said server, performs a function based on the result of the processing from said server.

11. A storage system according to claim 10, wherein the command is related to moving data or a set of data, and
wherein the message requests a change in the location of the data or individual locations of all data in the set within the metadata.

12. A storage system according to claim 10, wherein the command is related to deleting data or a set of data, and
wherein the message requests to delete an entry of the data or individual entries of all data in the set within the metadata.

13. A storage system according to claim 10, wherein the command is related to copying data, and
wherein the message requests a particular process to be performed, said process being one of:
copying the metadata once but not updating the metadata,
copying and updating the metadata, and
creating new metadata without copying the metadata.

14. A storage system according to claim 13, wherein the command is a copy command which is either in-system copying or remote copying.

15. A method for storing and managing unstructured data and associated metadata which describes attributes of the unstructured data in a storage system which includes a plurality of storage areas for storing the unstructured data and metadata, a server that manages the metadata, and a plurality of input/output (I/O) processing modules corresponding to said storage areas,
processing commands from a host including commands requesting access to the unstructured data of a corresponding storage area, and
communicating by a client with said server to process the metadata when a command being processed by an I/O processing module, containing the client, affects the metadata of the unstructured data stored in the corresponding storage area,
wherein the metadata includes pointer information which identifies a location of the unstructured data corresponding to the metadata.

16. A method according to claim 15, wherein each I/O processing module is one of a Fibre Channel (FC) adapter, a Network File System/Common Internet File System (NFS/CIFS) adapter and a Database (DB) adapter.

17. A method according to claim 15, wherein each I/O processing module contains a DB client as said client and said unstructured data is managed by a DB Management System (DBMS) as said server.

18. A method according to claim 17, wherein each I/O processing module is one of a Fibre Channel (FC) adapter and an Internet Protocol (IP) adapter and each of the DB clients is implemented as a software program executable by the corresponding adapter.

19. A method system according to claim 15, wherein said server is a DB server which can reside in one of a plurality of adapters serving as an interface to disk drives containing said storage areas or an interface to hosts accessing to said storage system.

20. A method according to claim 19, wherein the one adapter upon which the DB server resides has a program executing capability for executing software implementing the DB server.

21. A method according to claim 19, wherein a data structure or a schema of the metadata is configurable by users of the storage system but at least includes the pointer information.

22. A method according to claim 21, wherein descriptions of the location of the unstructured data are different among different I/O protocols, the schema includes information related to the descriptions.

23. A method according to claim 15, wherein when the command being processed by the I/O processing module is a metadata management command that manages the metadata of the unstructured data, the I/O processing module creates a message to be sent to said server based on the command and sends the message to said server,
wherein said server upon receipt of the message, processes the metadata according to the message and returns a result of the processing to the I/O processing module, and
wherein the I/O processing module upon receipt of the result of the processing from said server, returns the result of the processing to the host.

24. A method according to claim 15, wherein when the command being processed by the I/O processing module is an I/O command having a data management function that affects the metadata of the unstructured data, the I/O processing module creates a message to be sent to said server based on the I/O command and sends the message to said server,
wherein said server upon receipt of the message, processes the metadata according to the message and returns a result of the processing to the I/O processing module, and
wherein the I/O processing module upon receipt of the result of the processing from said server, performs a function based on the result of the processing from said server.

25. A method according to claim 24, wherein the command is related to moving data or a set of data,
wherein the message requests a change in the location of the data or individual locations of all data in the set within the metadata.

26. A method according to claim 24, wherein the command is related to deleting data or a set of data, and
wherein the message requests to delete an entry of the data or individual entries of all data in the set within the metadata.

27. A method according to claim 24, wherein the command is related to copying data,
wherein the message requests a particular process to be performed, said process being one of:
copying the metadata once but not updating the metadata,
copying and updating the metadata, and
creating new metadata without copying the metadata.

28. A method according to claim 27, wherein the command is a copy command which is either in-system copying or remote copying.

29. A storage system for storing and managing unstructured data and associated metadata which describes attributes of the unstructured data, said storage system comprising:
a storage for storing the unstructured data and metadata,
wherein the metadata includes pointer information which identifies a location of unstructured data corresponding to the metadata;
a storage controller for controlling said storage system,
wherein said storage controller includes a server that manages the metadata; and
a processor which processes commands from a host including commands requesting access to the unstructured data of the storage,
wherein said processor includes a client which communicates with said server to process the metadata when a command being processed by the processor affects the metadata of the unstructured data stored in the corresponding storage area.

30. A storage system according to claim 29, wherein said server is a DB server which can reside in one of a plurality of adapters serving as an interface to disk drives containing said storage areas or an interface to hosts accessing to said storage system.

31. A storage system according to claim 30, wherein the one adapter upon which the DB server resides has a program executing capability for executing software implementing the DB server.

32. A storage system according to claim 30, wherein a data structure or a schema of the metadata is configurable by users of the storage system but at least includes the pointer information.

33. A storage system according to claim 32, wherein descriptions of the location of the unstructured data are different among different I/O protocols, the schema includes information related to the descriptions.

34. A storage system according to claim 30, wherein when the command being processed by the processor is a metadata management command that manages the metadata of the unstructured data, the processor creates a message to be sent to said server based on the command and sends the message to said server,
wherein said server upon receipt of the message, processes the metadata according to the message and returns a result of the processing to the processor, and
wherein the processor upon receipt of the result of the processing from said server, returns the result of the processing to the host.

35. A storage system according to claim 30, wherein when the command being processed by the processor is an I/O command having a data management function that affects the metadata of the unstructured data, the processor creates a message to be sent to said server based on the I/O command and sends the message to said server,
wherein said server upon receipt of the message, processes the metadata according to the message and returns a result of the processing to the processor, and
wherein the processor upon receipt of the result of the processing from said server, performs a function based on the result of the processing from said server.

36. A storage system according to claim 35, wherein the command is related to moving data or a set of data, and
wherein the message requests a change in the location of the data or individual locations of all data in the set within the metadata.

37. A storage system according to claim 35, wherein the command is related to deleting data or a set of data, and
wherein the message requests to delete an entry of the data or individual entries of all data in the set within the metadata.

38. A storage system according to claim 35, wherein the command is related to copying data, and
wherein the message requests a particular process to be performed, said process being one of:
copying the metadata once but not updating the metadata,
copying and updating the metadata, and
creating a new metadata without copying the metadata.

39. A storage system according to claim 38, wherein the command is a copy command which is either in-system copying or remote copying.

40. A information processing system comprising:
a primary storage system for storing and managing unstructured data and associated metadata which describes attributes of the unstructured data; and
a secondary storage system, connected to said primary storage system, for storing a copy of the unstructured data and associated metadata stored in said primary storage system,
wherein said primary storage system implements a remote copy function with respect to said primary storage system by copying data to be stored in said primary storage system to said secondary storage system,
wherein each of said primary and secondary storage systems comprises:
a plurality of storage areas for storing the unstructured data and metadata,
wherein the metadata includes pointer information which identifies a location of unstructured data corresponding to the metadata,
a server that manages the metadata, and
a plurality of input/output (I/O) processing modules corresponding to said storage areas,
wherein each I/O processing module processes commands from a host including commands requesting access to the unstructured data of a corresponding storage area,
wherein each I/O processing module includes a client which communicates with said server to process the metadata when a command being processed by the I/O processing module affects the metadata of the unstructured data stored in the corresponding storage area,
wherein one of said I/O processing modules of each storage system is a remote copy processing module which is connected to the remote copy processing module of the other storage system, and
wherein the remote copy processing module of said primary storage system implements the remote copy function by sending a copy of unstructured data and associated metadata to be stored in said primary storage system to the remote copy processing module of said secondary storage system.

41. A information processing system comprising:
a plurality of hosts;
a first network;
a plurality of file servers which are interconnected to said hosts by said first network;
a server which is interconnected to said hosts by said first network
a second network; and
a plurality of storage systems which are interconnected to said file servers and said server by said second network,
wherein each storage system stores and manages unstructured data and associated metadata which describes attributes of the unstructured data and said server manages the metadata, said each storage system comprising:
a plurality of storage areas for storing the unstructured data and metadata,
wherein the metadata includes pointer information which identifies a location of unstructured data corresponding to the metadata,
wherein each file server processes commands from a host including commands requesting access to the unstructured data of a storage system, and
wherein each file server includes a client which communicates with said server to process the metadata when a command being processed by the file server affects the metadata of the unstructured data stored in the storage system.
